(19) United States
(12) Patent Application Publication
(10) Pub. No.: US 2008/0199200 A1
(43) Pub. Date: Aug. 21, 2008

(54) Computer readable recording medium stored with control program for controlling tab sheet insertion apparatus and control method thereof

(75) Inventors: Michihiro Nakagawa, Sagamihara-shi (JP); Tamotsu Sakuraba, Sagamihara-shi (JP); Toshimi Shinchi, Saitama-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/822,531

(22) Filed: Jul. 6, 2007

(30) Foreign Application Priority Data
Feb. 21, 2007 (JP) 2007-040730

(51) Int. Cl. G03G 15/00

(52) U.S. Cl. 399/81; 399/382; 399/82

(57) ABSTRACT

There is provided for a user a setting screen having a tab sheet insertion setting part for conducting insertion setting concerning insertion of tab sheets of a plurality of types, and a tab sheet discharge setting part for conducting discharge setting for discharging tab sheets that became no longer necessary classifying the tab sheets depending on the types. The insertion setting and the discharge setting specified by the user are received via this setting screen.

### CROSS-REFERENCE TO RELATED APPLICATION

This application is based on Japanese Patent Application No. 2007-040730 filed on Feb. 21, 2007, the contents of which are incorporated herein by reference.

### BACKGROUND

1. Technical Field

The present invention relates to a computer readable recording medium stored with a control program for controlling a tab sheet insertion apparatus having tab sheet inserting function and a control method thereof.

2. Description of the Related Art

There exist printing apparatuses such as copying machines and printers that are capable of creating printed products by inserting between pages a tab sheet having a flat rectangular main body and a tab protruding at a specified position on a side of said may body. See Unexamined Publication No. 2005-271259.

In such a printing apparatus having tab sheet inserting function, multiple sets of tab sheets consisting of, for example, five tab sheets, whose tab positions are sequentially offset from each other, are used as constituents and are placed in a sheet supply tray. If only first three tab sheets are used in a printing job, the remaining two tab sheets, i.e., the fourth and fifth tab sheets, become no longer necessary and must be discharged. This is because it is necessary to supply tab sheets starting with the first tab sheet of a set in the execution of the next print job.

In the printing apparatus described in said document, the tab sheets that became no longer necessary are discharged to a discharge tray separate from a discharge tray for sheets on which pages of the printing job are printed. As a result, the tab sheets that became no longer necessary can be removed easily as they are not mixed with the normally printed sheets.

However, there are cases where the user wishes to insert a plurality of types of tab sheets, e.g., a case of inserting different types of tab sheets for page locations denoting “chapter” breaks and page locations denoting “section” breaks respectively. In this case, even if the tab sheets that became no longer necessary are discharged into a separate discharge tray, separate from the normally printed sheets, a plurality of types of tab sheets that became no longer necessary exist in a single discharge tray in a mixed state. Therefore, the user has to sort the tab sheets out manually if it is desired to reuse those tab sheets that became no longer necessary, so that it is a burden to the user.

### SUMMARY

To solve at least one of the abovementioned problems, there is provided a computer readable recording medium stored with a control program for controlling a tab sheet insertion apparatus, which reflects one aspect of the present invention. The control program causes a computer to execute a process comprising: providing a user a setting screen having a tab sheet insertion setting part for conducting insertion setting concerning insertion of tab sheets of a plurality of types, and a tab sheet discharge setting part for conducting discharge setting for discharging tab sheets that became no longer necessary classifying the tab sheets depending on the types; and receiving said insertion setting and said discharge setting specified by the user via said setting screen.

The tab sheet discharge setting part preferably comprises a first tab sheet discharge destination setting part which enables the user to specify a first discharge destination for a first tab sheet that became no longer necessary, and a second tab sheet discharge destination setting part which enables the user to specify a second discharge destination for a second tab sheet that became no longer necessary.

The tab sheet discharge setting part preferably comprises a tab sheet type separation setting part that enables the user to specify discharge of the tab sheets with a separation sheet inserted at a breakpoint where the type of the tab sheets that became no longer necessary changes.

The tab sheet discharge setting part preferably comprises a tab sheet type offset setting part that enables the user to specify offsetting the discharge position of the tab sheet that became no longer necessary depending on the tab sheet type.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a network system according to a first embodiment of the present invention.

FIG. 2 is a block diagram showing the constitution of the PC shown in FIG. 1.

FIG. 3 is a block diagram showing the constitution of the printer controller of the printing system shown in FIG. 1.

FIG. 4 is a block diagram showing the constitution of the printer of the printing system shown in FIG. 1.

FIG. 5 is a diagram showing the typical constitution of a printing unit.

FIG. 6A is a diagram showing three tab sheets used in this embodiment.

FIG. 6B is a diagram showing five tab sheets used in this embodiment.

FIG. 7 is a flow chart showing the process procedure on the PC.

FIG. 8 is a flowchart showing the procedure for a process of receiving an instruction on a method of discharging tab sheets that became no longer necessary.

FIG. 9 is an example of tab sheet setting screen in a first embodiment.

FIG. 10 is a flowchart showing the process sequence on the printer controller.

FIG. 11 is a flowchart showing the process sequence on the printer.

FIG. 12 is a flowchart showing the procedure of the printing process.

FIG. 13 is a flow chart, continuing from FIG. 12, showing the printing procedure.

FIG. 14 is a conceptual diagram of the header information.

FIG. 15 is a diagram for describing another method of discharging tab sheets that became no longer necessary.

FIG. 16 is a diagram for describing still another method of discharging tab sheets that became no longer necessary.

FIG. 17 is a diagram for describing the method of discharging tab sheets that became no longer necessary by turning them over.

FIG. 18 is an example of tab sheet setting screen in a second embodiment.

FIG. 19 is an example of tab sheet setting screen in a third embodiment.

### DETAILED DESCRIPTION

The embodiment of this invention will be described below with reference to the accompanying drawings.

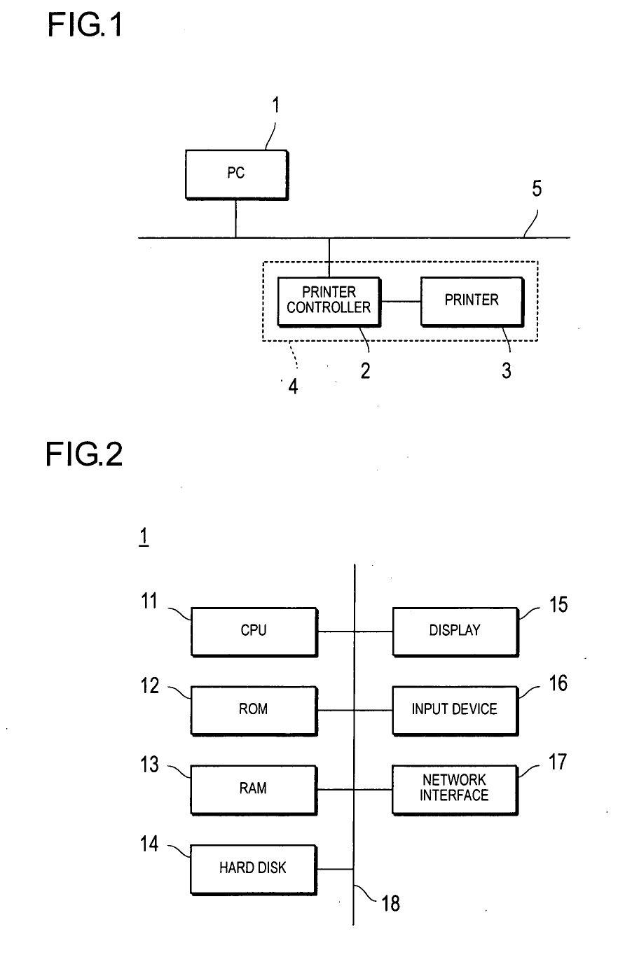

FIG. 1 is a block diagram showing the overall constitution of a network system according to a first embodiment of the present invention.

The network system that relates to this embodiment is equipped with a PC 1 as a printing instruction device for instructing the printing of the document and a printing system 4 for conducting printing based on printing instructions of the PC 1, which are connected with each other via a network 5. Also, the PC 1 and the printing system 4 can be connected directly (local connection) without recourse to the network 5.

The printing system 4 consists of a printer controller 2 and a printer 3 as an image forming apparatus and also as a tab sheet insertion apparatus, which are locally connected with each other. This local connection can be accomplished by means of various local connection interfaces, such as serial interfaces, e.g., USB and IEEE 1394, parallel interfaces, e.g., SCSI and IEEE 1284, wireless communication interfaces, e.g., Bluetooth®, IEEE 802.11, HomeRF®, IrDA®, etc. However, the printer controller 2 and the printer 3 can be connected via the network 5.

FIG. 2 is a block diagram showing the constitution of PC 1 shown in FIG. 1.

The PC 1 contains a CPU 11, a ROM 12, a RAM 13, a hard disk 14, a display 15, an input device 16 and a network interface 17, all of which are interconnected via a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

An application program for generating document files and a printer driver for converting the document files into PDL data described in a Page Description Language (“PDL”) understood by the printing system 4 are installed on the hard disk 14. The printer driver is capable of providing instructions for printing document files prepared with the use of applications, setting up printing output conditions, and setting up tab sheet related matters. The printer drive contains programs for executing these settings.

The display 15 can be LCD, CRT, and other displays, on which various kinds of information are displayed. The input device 16 includes a pointing device such as a mouse, a keyboard, and others, and is used for executing various kinds of information inputs.

The network interface 17 is an interface for communicating with other devices on the network via the network 5 using standards such as Ethernet®, Token Ring, FDDI, etc.

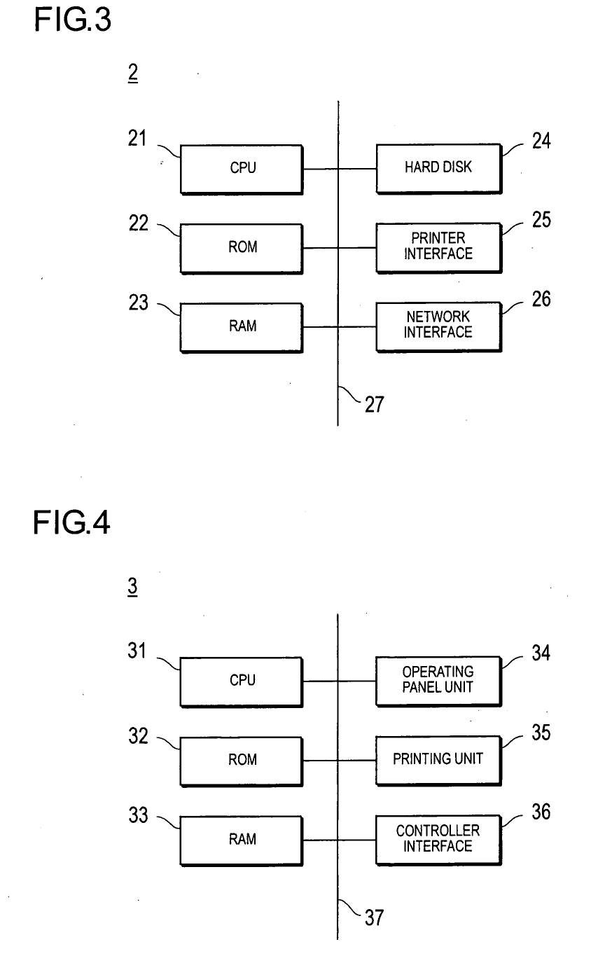

FIG. 3 is a block diagram showing the constitution of the printer controller 2 of the printer system 4 shown in FIG. 1.

The printer controller 2 is provided with a CPU 21, a ROM 22, a RAM 23, a hard disk 24, a printer interface 25, and a network interface 26, all of which are interconnected with each other via a bus 27 for exchanging signals. The descriptions of those parts of the printer controller 2 that have the same functions as those of the corresponding parts of the PC 1 will be omitted here to avoid being duplicative.

The ROM 22 and hard disk 24 stores a rasterizing process program for translating PDL data received from PCI and developing it into bitmap data, which is bitmap type image data, as well as an image data process program for analyzing the received PDL data. The received PDL data and the bitmap data can be saved on the hard disk 24.

The printer interface 25 is an interface for communicating with the locally connected printer 3.

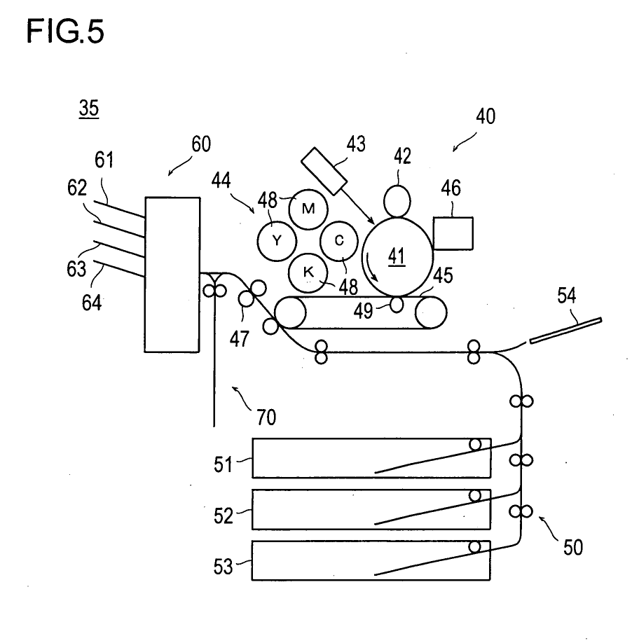

FIG. 4 is a block diagram showing the constitution of the printer 3 of the printing system 4 shown in FIG. 1. The printer 3 has a CPU 31, a ROM 32, a RAM 33, an operating panel unit 34, a printing unit 35, and a controller interface 36, all of which are interconnected with each other via a bus 37 for exchanging signals. The descriptions of those parts of the printer 3 that have the same functions as those of the corresponding parts of the PC 1 will be omitted here to avoid being duplicative.

The ROM 32 stores a printing process program to be executed based on printing data containing bitmap data received from the printer controller 2.

The operating panel unit 34 is equipped with a touch panel, a ten-key pad, a start button, a stop button and others to be used for displaying various data and entering various instructions.

The printing unit 35 prints images based on bitmap data received from the printer controller 2 using a publicly known imaging process such as the electronic photography process on recording media such as paper. The controller interface 36 is an interface for communicating with the locally connected printer controller 2.

FIG. 5 is a diagram showing the typical constitution of a printing unit 35.

The printing unit 35 has a paper supply unit 50 for supplying recording media such as printing paper and insertion sheets such as tab sheets, an image forming unit 40 for forming images on the recording media, and a paper discharge unit 60 for discharging printing paper and tab sheets. The printing unit 35 also has a reversing mechanism unit 70 for reversing the front and back sides of printing paper.

The image forming unit 40 of the printing unit 35 has a sensitizer drum 41 that rotates in the arrow direction, a charging device 42, exposing device 43, a developing device 44, an intermediate transfer belt 45, a cleaning device 46, and a fixing device 47. After the surface of the sensitizer drum 41 is evenly charged by means of the charging device 42, an electrostatic latent image is formed on the surface of the sensitizer drum 41 as it is irradiated with laser beams by the exposing device 43. The electrostatic latent image becomes an apparent image as the toner adheres to the electrostatic latent image on the sensitizer drum 41 in accordance with the rotation of the sensitizer drum 41. The developing device 44 has developing rollers 48 of cyan (C), magenta (M), yellow (Y), and black (K) respectively. The toner images of these colors thus becoming apparent images are then transported to the transferring unit 49 where they are transferred onto the intermediate transfer belt 45 one after the other to be overlaid on top of each other. The overlaid color images are then transferred onto the printing paper supplied by the paper supply unit 50. The toner images are then fixed on the printing paper by the fixing device 47 and transported to the paper discharge unit 60.

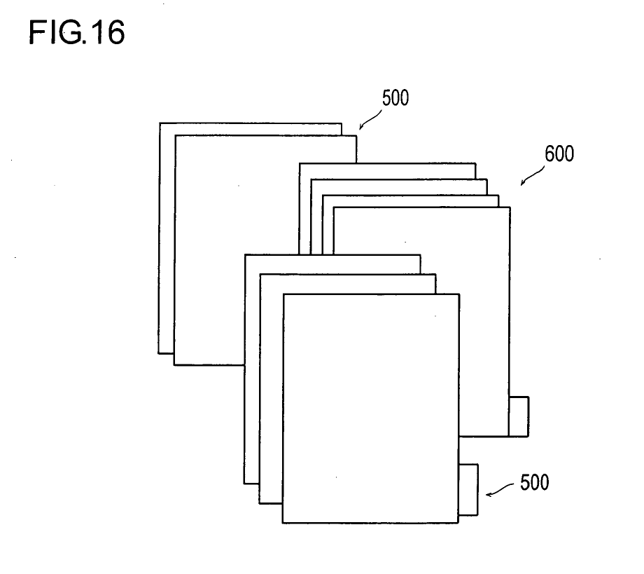

The paper supply unit 50 has a plurality of sheet supply trays 51-54. The sheet supply tray 54 is a manual feed sheet supply tray. The paper discharge unit 60 is equipped with a plurality of paper discharge trays 61-64. The paper discharge unit 60 is equipped with a mechanism for offsetting the discharge position, i.e., for shifting the discharge position into a direction perpendicular to the transport direction (FIG. 16). The paper discharge unit 60 may have a post-processing unit for providing post-processes such as punching or stapling to the printing paper transported there.

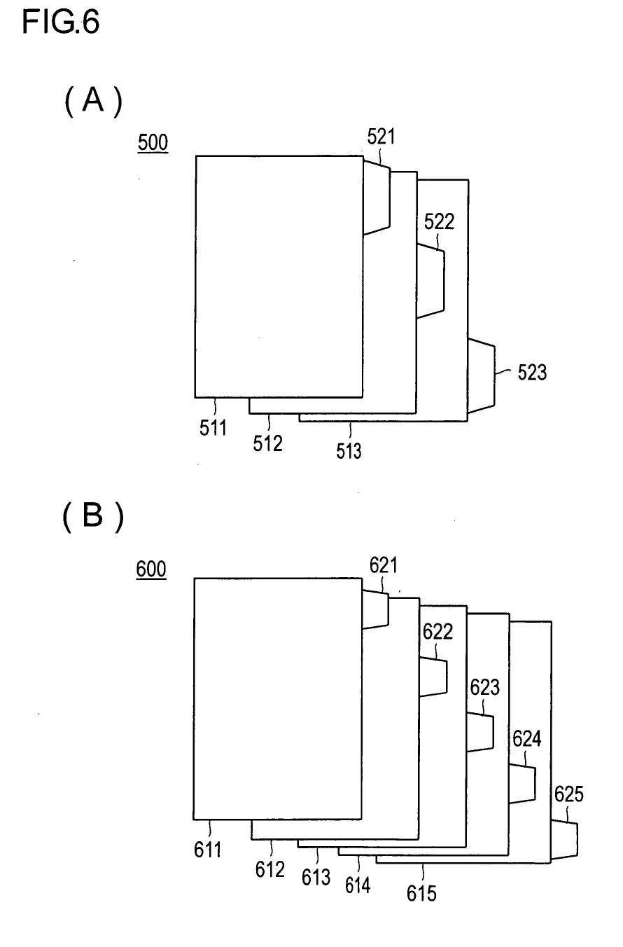

FIG. 6A and 6B show examples of the tab sheet used in this embodiment. FIG. 6A shows a three tab sheet 500 and FIG. 6B shows a five tab sheet 600. Tab sheets are also called index sheets. As shown in FIG. 6A, the tab sheet 500 is a set consisting of three sheets 511-513 and is called a “three-tab.” Each of the tab sheets 511-513 has a flat rectangular main body and a tab 521-523 respectively protruding at a specified position on a side of said main body. As shown in FIG. 6B, the tab sheet 600 is a set consisting of five sheets 611-615 and is called a “five-tab.” Each of the tab sheets 611-615 has a flat rectangular main body and a tab 621-625 respectively protruding at a specified position on a side of said main body.

The order of the tab sheets shown in FIG. 6 is called the normal order and is arranged in such a way that the tab of an upper layer sheet is found above the tab of a lower layer sheet in FIG. 6 when all of their tabs are on the right side. In case of the three-tab sheet 500, the tabs 521-523 are provided on one side of the main body lowering their positions sequentially in three steps from the top to the bottom. The positions of the tabs 521, 522, and 523 are identified as ⅓ (one-third), ⅔ (two-thirds), and 3/3 (three-thirds) respectively. In case of the five-tab sheet 600, the tabs 621-625 are provided on one side of the main body lowering their positions sequentially in five steps from the top to the bottom. The positions of the tabs 621, 622, 623, 624, and 625 are identified as ⅕ (one-fifth), ⅖ (two-fifths), ⅗ (three-fifths), ⅘ (four-fifths), and 5/5 (five-fifths) respectively. The tab sheets 500 and 600 are normally provided in multiple sets in the sheet supply tray.

The operation of the network system in this embodiment will be described in the following.

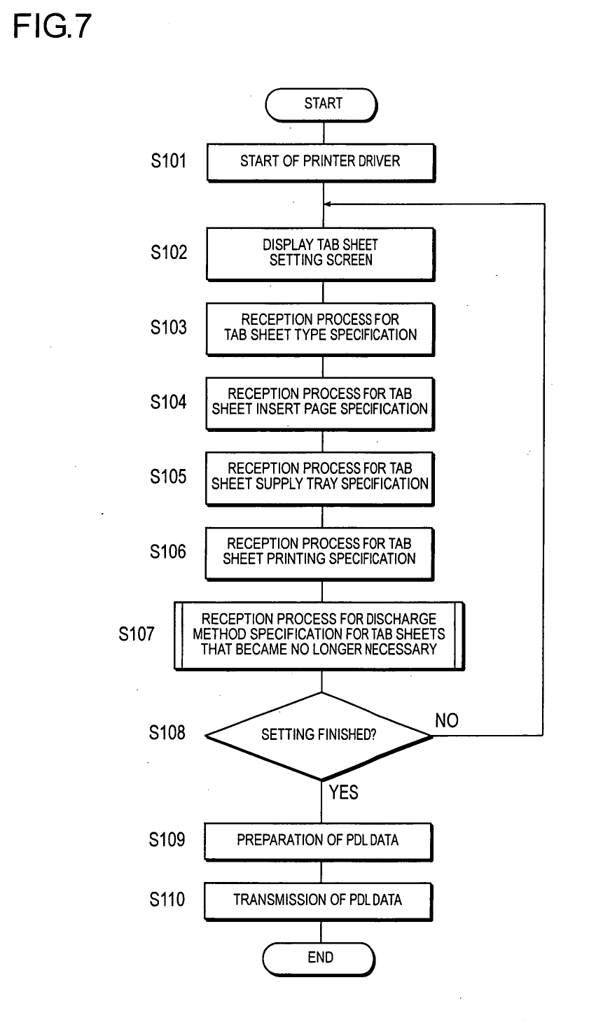

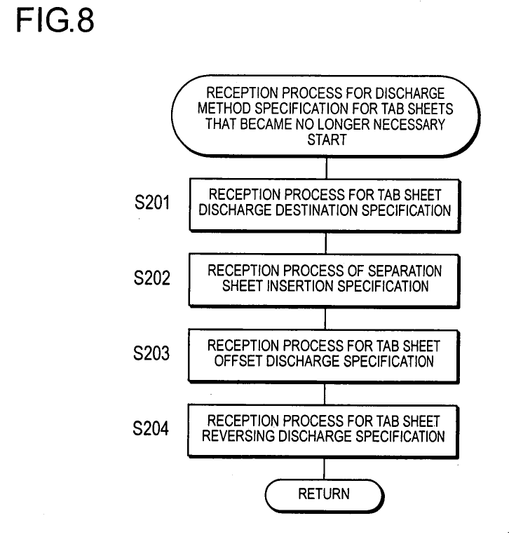

FIG. 7 and FIG. 8 are flow charts showing the process procedure on the PC 1. The algorithms shown in the flow charts of FIG. 7 and FIG. 8 are stored as a program in a storage unit such as a hard disk 14 of the PC 1 and executed by the CPU 11.

As a preamble, a document file to be printed is prepared by the PC 1. The document file is prepared by an application installed on the PC 1.

When the printing process for a document file is executed, the printer driver is activated via printing setting dialogs of the application based on the user's operation (S101).

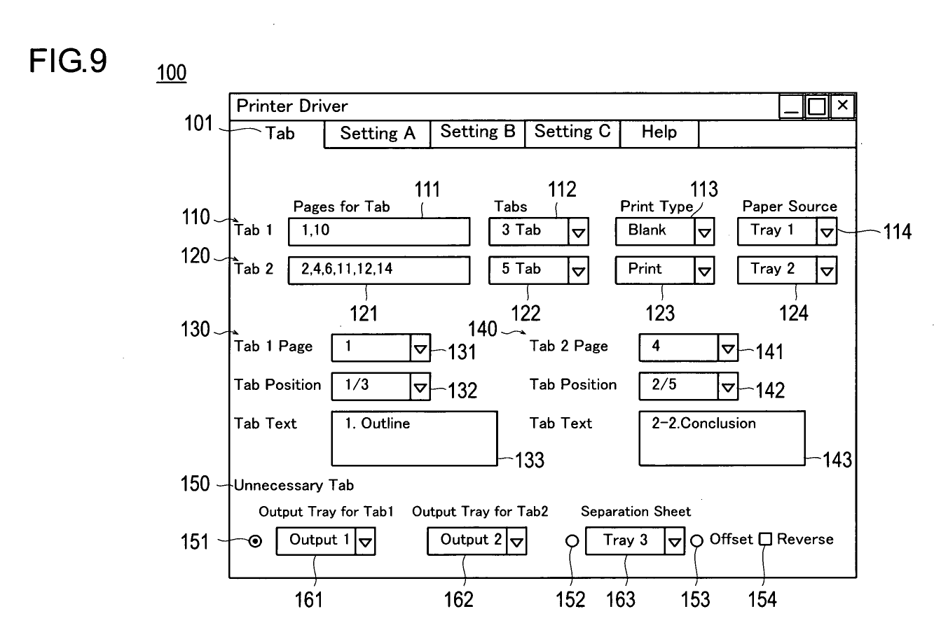

Next, when a tab paper setting button 101 (See FIG. 9) is clicked on the printing setting screen which is displayed by the printer driver, the tab paper setting start request is accepted and the tab sheet setting screen is displayed on the display 15 (S102).

FIG. 9 is a diagram showing an example tab sheet setting screen 100.

The tab sheet setting screen 100 has a first tab sheet insertion setting part 110 for setting up the first tab sheet's insertion, and a second tab sheet insertion setting part 120 for setting up the second tab sheet's insertion.

The first tab sheet insertion setting part 110 includes a first insertion page position setting part 111 which the user can use to specify the insertion page position where a tab sheet is inserted, and the second tab sheet insertion setting part 120 includes a second insertion page position setting part 121 which the user can use to specify the insertion page position where a tab sheet is inserted. Here the term “page” signifies a page of a document which is the object of the printing process and is a notion that does not include the tab paper. In the present embodiment, the tab sheet is inserted ahead of the page designated as the insertion page position in the setting process. However, the tab sheet can be inserted behind the page designated as the insertion page position in the setting process.

The first tab sheet insertion setting part 110 includes a first tab sheet type setting part 112 that the user can use for selecting a type of tab sheet, and the second tab sheet insertion setting part 120 includes a second tab sheet type setting part 122 that the user can use for selecting another type of tab sheet. The first tab sheet type setting part 112 and the second tab sheet type setting part 122 each displays a plurality of options for selecting the type of tab sheet. The type of tab sheet is not limited to the three-tab and five-tab sheets shown in FIG. 6 and can include tab sheets consisting of more tabs such as seven tabs and 10 tabs, or tab sheets of different colors.

The first tab sheet insertion setting part 110 includes a first tab printing setting part 113 for setting up whether any printing is to be executed on the tab of the tab sheet, and the second tab sheet insertion setting part 120 includes a second tab printing setting part 123 for setting up whether any printing is to be executed on the tab of the tab sheet. The available options here are “Print” and “Blank,” where selecting “Print” causes the tab to be printed and selecting “Blank” causes the tab not to be printed.

The first tab sheet insertion setting part 110 includes a first sheet supply tray setting part 114 that the user can use for selecting a tab sheet supply tray, and the second tab sheet insertion setting part 120 includes a second sheet supply tray setting part 124 that the user can use for selecting another tab sheet supply tray. The first sheet supply tray setting part 114 and the second sheet supply tray setting part 124 each displays a plurality of options for selecting sheet supply trays. Here “Tray1” designates a sheet supply tray 51 and “Tray 2” designates a sheet supply tray 52 (see FIG. 5).

The tab sheet setting screen 100 further has a first tab sheet setting part 130 for setting up a tab sheet that corresponds to the inserting page position set up in the first insertion page position setting part 111, and a second tab sheet setting part 140 for setting up a tab sheet that corresponds to the inserting page position set up in the second insertion page position setting part 121.

The first tab sheet setting part 130 includes a first object page position setting part 131 that the user can use for designating an object page position in the setting process, and the second sheet setting part 140 includes a second object page position setting part 141 that the user can use for designating an object page position in the setting process. Here the first object page position setting part 131 selectively displays the insertion page position set up in the first page position setting part 111. For example, in case of FIG. 9, the first object page position setting part 131 displays two options of page 1 or 10. The second object page position setting part 141 selectively displays the insertion page position set up in the second page position setting part 121. For example, in case of FIG. 8, the second object page position setting part 141 displays six options of page 2, 4, 6, 11, 12 or 14.

The first tab sheet setting part 130 includes a first tab position setting part 132 for designating the tab position on the tab sheet that corresponds to the insertion page position designated in the first insertion page position setting part 111, and the second tab sheet setting part 140 includes a second tab position setting part 142 for designating the tab position on the tab sheet that corresponds to the insertion page position designated in the second insertion page position setting part 121.

The first tab sheet setting part 130 includes a first tab printing information setting part 133 for designating the tab printing information on the tab sheet that corresponds to the insertion page position designated in the first insertion page position setting part 111, and the second tab sheet setting part 140 includes a second tab printing information setting part 143 for designating the tab printing information on the tab sheet that corresponds to the insertion page position designated in the second insertion page position setting part 121.

The tab sheet setting screen 100 further has a tab sheet discharge setting part 150 for setting up a process of classifying and discharging tab sheets which became no longer necessary based on tab sheet types. For example, if only the tab sheets 621, 622 and 623 out of all the constituents of the five-tab sheet 600 are used in a printing job, the remaining constituents 624 and 625 become no longer necessary as it is necessary to use the tab sheets starting with the tab sheet 621 in the execution setting for the next printing job.

The tab sheet discharge setting part 150 includes a separate discharge setting part 151 for setting up the discharge of tab sheets that became no longer necessary classifying them to discharge them into separate discharge trays; a tab sheet type separation setting part 152 for enabling the user to specify the setting for discharging tab sheets of a plurality of types that became no longer necessary by inserting a separating sheet at each point where the tab sheet type changes; and an offset setting part 153 for enabling the user to specify the setting for discharging tab sheets of a plurality of types that became no longer necessary by offsetting the positions in accordance with the types of tab sheets. It is so arranged that the use can select one of the setting parts 151-153. The setting parts 151-153 are radio buttons.

The separate discharging setting part 151 includes a first discharge tray setting part 161 that enables the user to specify a discharge tray for a first tab sheet that became no longer necessary and a second discharge tray setting part 162 that enables the user to specify a discharge tray for a second tab sheet that became no longer necessary. Here “Output 1” designates a sheet discharge tray 61 and “Output 2” designates a sheet discharge tray 62 (see FIG. 5). Moreover, the tab sheet type separation setting part 152 includes a sheet supply tray setting part 163 that enables the user to specify a sheet supply tray, which is the supply source of sheets to be used for separating the tab sheet types. “Tray 3” designates a sheet supply tray 53 (see FIG. 5).

The tab sheet discharge setting part 150 includes a reversing setting part 154 that enables the user to specify reversing of the front and back sides of the unnecessary tab sheets before they are discharged. The reversing setting part 154 is a checkbox. When this checkbox is check-marked, the front-and-back reversing function is set up.

Going back to the flowchart of FIG. 7, the reception process for the instruction for specifying the type of tab sheet in step S103 is executed. In other words, when the first tab sheet type is specified in the first tab sheet type setting part 112 or the second tab sheet type in the second tab sheet type setting part 122, such specifying instructions by the user are received here.

In step S104, the reception process for the instruction for specifying a tab sheet insertion page is executed. In other words, when the first tab sheet insertion page is specified in the first insertion page position setting part 111 or the second tab sheet insertion page in the second tab sheet typesetting part 121, such specifying instructions by the user are received here.

In step S105, the reception process for the specifying instruction for the sheet supply tray for supplying tab sheets is executed. In other words, when the first sheet supply tray is specified in the first sheet supply tray setting part 114 or the second sheet supply tray in the second sheet supply tray setting part 124, such specifying instructions by the user are received here.

In step S106, the reception process for the specifying instruction for tab sheet printing is executed.

In other words, when it is specified whether or not to print on the tab of the first tab sheet in the first tab printing unit 113 or whether or not to print on the tab of the second tab sheet in the second tab printing unit 123, such specifying instructions by the user are received here.

Next, when the object page position is specified in the first object page position setting part 131 for setting up the tab sheet that corresponds to the insertion page position set up in the first insertion page position setting part 111, such a specifying instruction by the user is received here. Also, when the position of the tab for the tab sheet is specified in the first tab position setting part 132, such a specifying instruction by the user is received here. Also, when the information for printing the tab for the tab sheet is specified in the first tab printing information setting part 133, such an instruction by the user is received here. The reception process for the specifying instruction in the second tab sheet setting part 140 is executed in the same way as the reception process for the specifying instruction in the first tab sheet setting part 130.

The first object page position setting part 131 displays the insertion page position set up at the first insertion page position setting part 111 to be selectable, and the second object page position setting part 141 displays the insertion page position set up at the second insertion page position setting part 121 to be selectable. This improves the user's productivity and prevents errors in the setting.

In step S107, the reception process for the specifying instruction for tab sheet that became no longer necessary is executed. The reception process for the instruction specifying the discharge method for tab sheets that became no longer necessary will be described later.

The execution order for steps S103-S107 can be arbitrarily changed.

In step S108, a judgment is made as to whether the setting work on the tab sheet setting screen 100 has been completed or not. For example, when the display is switched to a different printing setting screen from the tab sheet setting screen 100 and the instruction button for printing start (not shown) is clicked, it is judged that the setting work at the tab sheet setting screen 100 is finished. If the setting work at the tab sheet setting screen 100 has not been completed (S108: No), the system returns to step S102.

If the setting work at the tab sheet setting screen 100 has been completed (S108: Yes), PDL data is generated by means of converting the document file prepared by using the application (S109).

At this point, the setting information set up based on the user's specifying instructions concerning the tab sheet in the abovementioned steps S103-S107 is described as command data in the PDL data. Other setting information is described as command data in the PDL data.

Next, in step S1110, the PDL data thus prepared is transmitted to the printer controller 2 of the printing system 4 via the network 5.

Next, the reception process concerning the instruction specifying the discharge method for the tab sheets that became unnecessary will be explained below with reference to FIG. 8.

First, the reception process concerning the instruction specifying the discharge destination of tab sheets is executed (S201). In other words, the instruction specifying the tab sheet discharge destination is received when the separate discharge setting part 151 is selected by the user. At this point, the instruction specifying the discharge tray, which is the first discharge destination for tab sheets that became no longer necessary in the first discharge tray setting part 161, and the instruction specifying the discharge tray, which is the second discharge destination for tab sheets that became no longer necessary in the second discharge tray setting part 162 are received.

In step S202, the reception process for the instruction specifying the separating sheet insertion is received. In other words, when the tab sheet type separation setting part 152 is selected by the user, the instruction specifying the separating sheet insertion is received. At this point, the instruction specifying a sheet supply tray, which is the supply source for the separation sheets in the sheet supply tray setting part 163 is received.

In step S203, the reception process for an instruction specifying the offset discharge of the tab sheets that became no longer necessary is executed. In other words, the instruction specifying the offset discharge of tab sheets that became no longer necessary is received when the tab sheet type offset setting part 153 is selected by the user.

Moreover, in this embodiment, either one of the separate discharge setting part 151, the tab sheet type separation setting part 152, and the tab sheet type offset setting part 153 is selected.

In step S204, the reception process for the reversing discharge instruction for discharging the tab sheets that became unnecessary by reversing them front to back. In other words, when the user enters a check mark in the reversing setting part 154, a reversing discharge instruction is received for discharging the tab sheets that became no longer necessary by reversing them front to back.

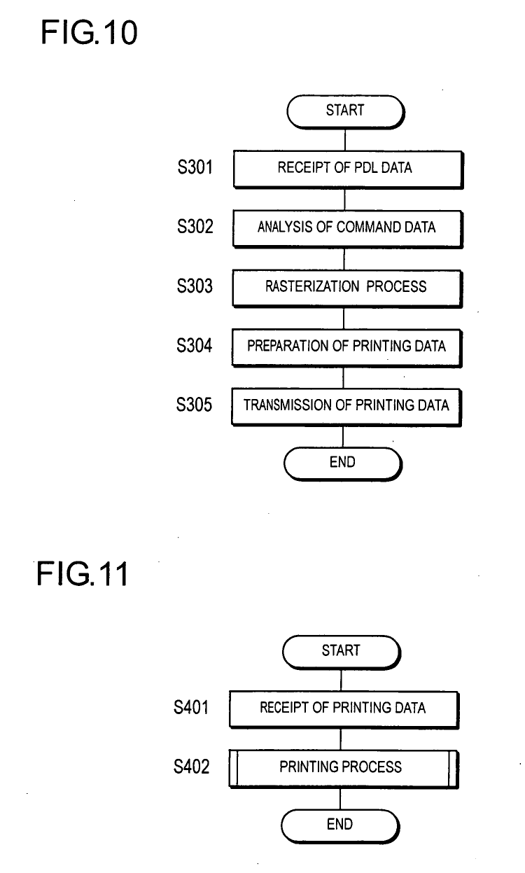

Next, the process on the printer controller 2 will be described below referring to FIG. 10. The algorithm shown in the flowchart of FIG. 10 is stored as a program in a storage unit such as a hard disk 24 of the printer controller 2 and executed by the CPU 21.

First, the printer controller 2 receives the PDL data from the PC1 (step S301), and analyzes the command data described in the PDL data (S302). Here, the setting information concerning the tab sheet is identified as the command data is analyzed.

Next, the received PDL data is rasterized in order to obtain bitmap data, which is bitmap type image data (S303).

Printing data is then prepared by adding header information containing setting information concerning the tab sheet to the bitmap data thus obtained in step S303 (S304), and the particular printing data is transmitted to the printer 3 as a printing job (S305).

Next, the process on the printer 3 will be described below referring to FIGS. 11-13. The algorithm shown in the flowcharts of FIGS. 11-13 is stored as a program in a storage unit such as a ROM 32 of the printer 3 and executed by the CPU 31.

The printer 3 receives the printing data from the printer controller 2 as the printing job (step S401). Next, the printer 3 executes the printing process (S402).

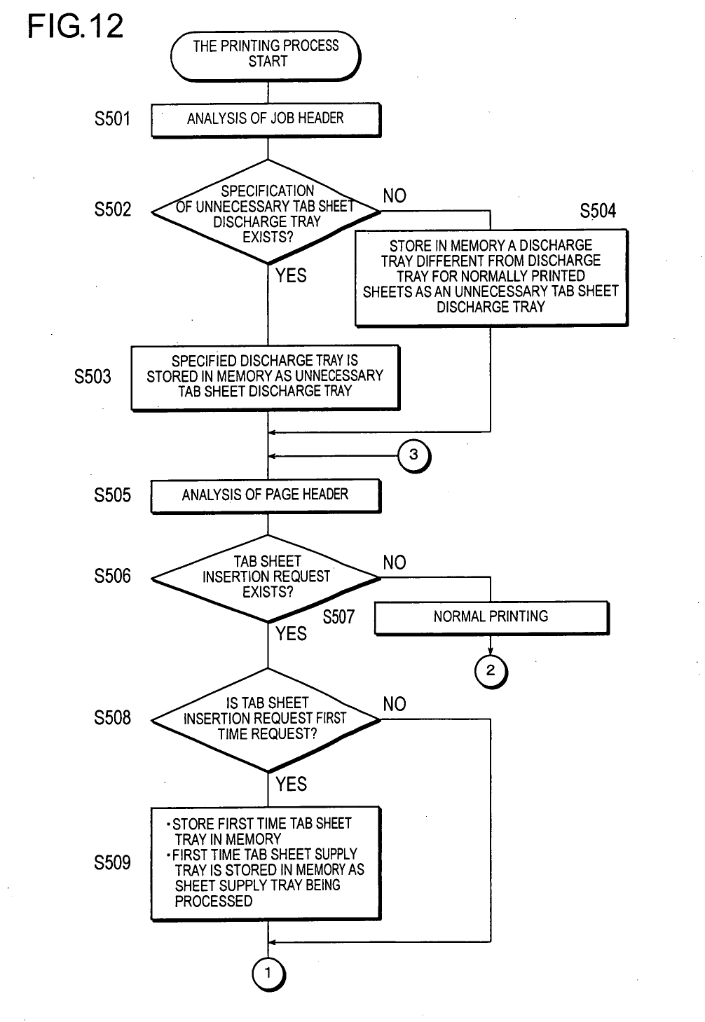

As the printing process is initiated, the job header contained in the header information is first analyzed as shown in FIG. 12 (S501)

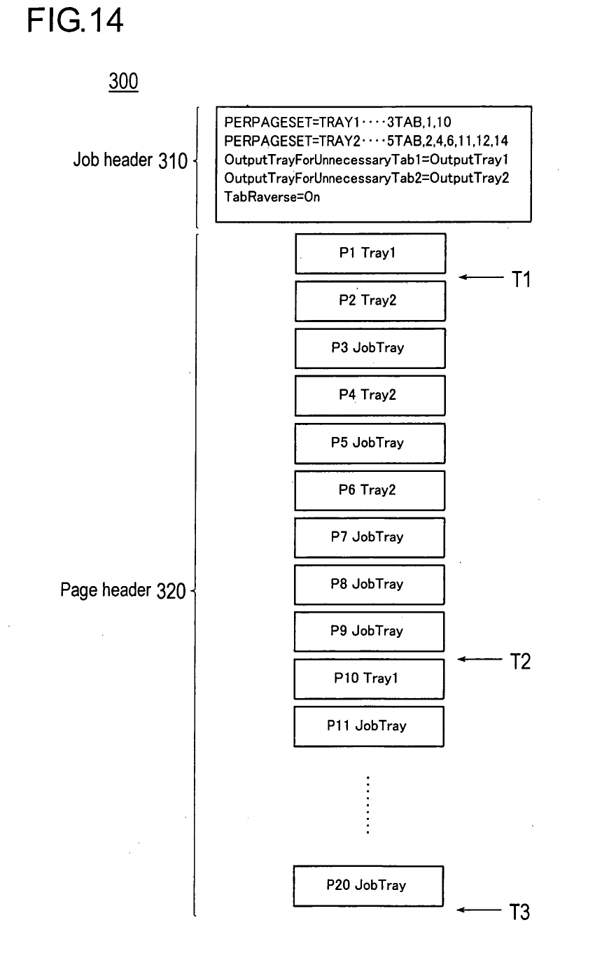

FIG. 14 is a conceptual diagram of the header information. The header information 300 comprises a job header 310 which is an additional information related to the entire printing job and a job header 320 which is an additional information related to specific pages included in the printing job.

For example, the job header 310 in FIG. 14 contains the setting information concerning the tab sheets consisting of the following contents. For example, the supply source of the first tab sheet is “Tray 1” (the sheet supply tray 51 shown in FIG. 5), the type of the first tab sheet is 3-tab, and the insertion page locations of the first tab sheet are pages 1 and 10. Also, the supply source of the second tab sheet is “Tray 2” (the sheet supply tray 52 shown in FIG. 5), the type of the second tab sheet is 5-tab, and the insertion page locations of the second tab sheet are pages 2, 4, 6, 11, 12, and 14. The discharge destination of the first tab sheet that became no longer necessary is “OutputTray 1” (the discharge tray 61 shown in FIG. 5), and the discharge destination of the second tab sheet that became no longer necessary is “OutputTray 2” (the discharge tray 62 shown in FIG. 5). Also, there is a reversing discharge instruction for reversing the front and back sides of the tab sheets that became no longer necessary.

In the page header 320 shown in FIG. 14, “P1,” “P2,” denote the page numbers to be printed, “Tray1” and “Tray2” denote the sheet supply trays that supply the tab sheets to those page positions, and “JobTray” indicate that there is no tab sheet to be inserted to those pages and the sheets to be used for printing those pages are supplied from the sheet supply trays specified by the printing job.

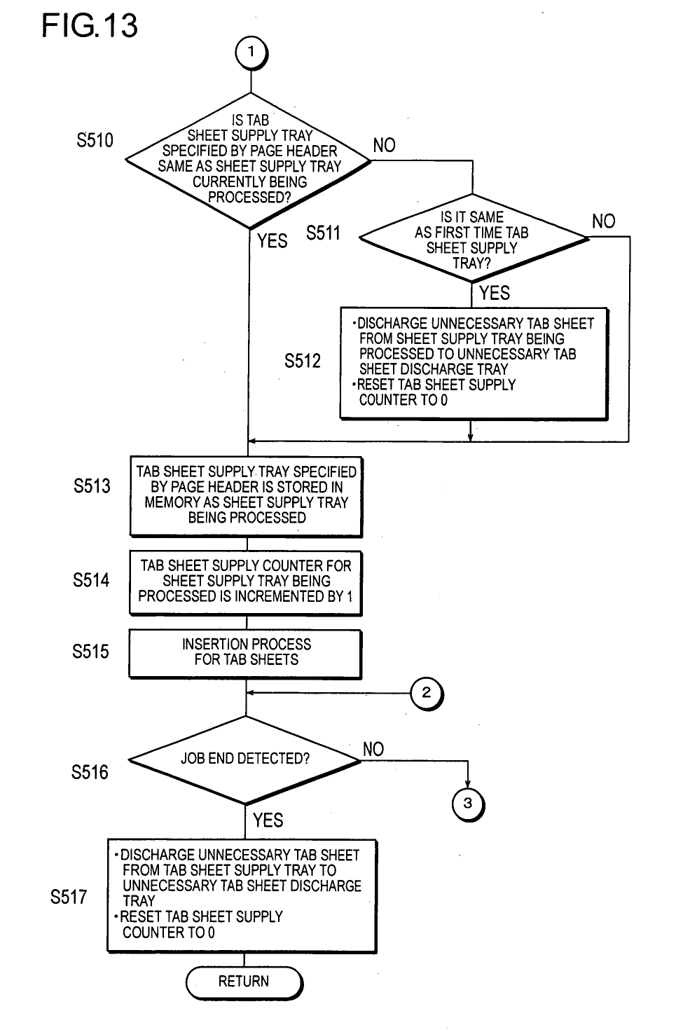

The flowchart shown in FIG. 12 and FIG. 13 is used to describe a method of discharging a plurality of types of sheets that became no longer necessary to different discharge trays depending on the types of tab sheets.

In step S502, a judgment is made as to whether or not a discharge tray is specified for a tab sheet that became no longer necessary.

If there is a discharge tray specified as the discharge destination for the tab sheet that became no longer necessary (S502: Yes), the specified discharge tray is stored in a memory such as the RAM 33 as an unnecessary tab sheet discharge tray (S503). On the contrary, if no discharge tray is specified as the discharge destination for a tab sheet that has become no longer necessary (S502: No), a discharge tray different from the discharge tray used for normally printed sheets as an unnecessary tab sheet discharge tray in the memory (S504).

Next, the page header 320 is analyzed (S505). The analysis of the page header 320 is conducted for the process of each page in accordance with the description of the printing job in sequence. The process on the tab sheet and the process on normal pages being printed are executed individually.

Based on the analysis of the page header 320, a judgment is made whether or not there is a demand for tab sheet insertion (S506).

If there is no request for tab sheet insertion (S506: No), normal printing, i.e., printing of one page portion of the current printing job is executed (S507), and the program advances to step S516.

When a tab sheet insertion request exists (S506: Yes), a judgment is made whether said tab sheet insertion request is the first time request or not (S508).

If it is judged that it is a tab sheet insertion request of the first time (S508: Yes), the sheet supply tray specified for the first time tab sheet insertion request (hereinafter called “first time tab sheet supply tray”) is stored in the memory. The first time tab sheet supply tray is stored in the memory as the sheet supply tray being processed.

On the other hand, if it is judged that it is not the tab sheet insertion request of the first time (S508: No), the program advances to step S510.

In step S510, a judgment is made whether or not the tab sheet supply tray specified at the page header 320 is the same as the currently processed sheet supply tray stored in the memory. In other words, a judgment is mad whether or not the sheet supply tray for the tab sheet to be used has changed.

If it is judged that the tab sheet supply tray specified at the page header 320 is the same as the currently processed sheet supply tray stored in the memory (S510: Yes), the program advances to step S513.

In step S513, the tab sheet supply tray specified by the page header 320 is stored in the memory as the sheet tray currently being processed.

Next, the tab sheet supply count is incremented by 1 for the sheet tray being currently processed (S514). The tab sheet supply count (initial value=0) is counted per each tab sheet tray and is stored in the memory per each tab sheet supply tray.

Then, the tab sheet insertion process is executed (S515). In other words, a tab sheet is supplied from the sheet supply tray being currently processed, which is stored in the memory, and is inserted at the specified page position.

In step S516, a judgment is made as to whether the job end of the printing data is detected or not. In other words, it is judged whether all the processes concerning the printing data have been completed or not.

If the job end is not detected (S516: No), the program returns to step S505 and executes the following process.

If, on the other hand, it Is judged that the tab sheet supply tray specified by the page header 320 in step S510 is different from the sheet supply tray, which is stored in the memory as the one being currently processed (S510: No), a judgment is made as to whether or not the tab sheet supply tray specified by the page header 320 is the same as the initial tab sheet supply tray, which is stored in the memory (S511). In other words, a judgment is made whether the tab sheet tray being used is the initial tab sheet tray returned from another tab sheet supply tray or a tab sheet tray changed from the initial tab sheet supply tray.

If it is judged that the tab sheet tray being used is a tab sheet supply tray changed from the initial tab sheet supply tray (S511: No, T1 shown in FIG. 14), the program advances to step S513. This is a case where the first tab sheet inserted is of 3-tab, and the second tab sheet is of 5-tab, i.e., a case when a 3-tab sheet is inserted first and then a 5-tab sheet insertion request is made. In this case, the sheet supply tray after the switch is made is stored in the memory as the sheet supply tray being currently processed in step S513.

On the other hand, if it is judged that the tab sheet tray being used is the initial tab sheet supply tray changed from another tab sheet supply tray (S511: Yes, T2 shown in FIG. 14), the program advances to step S512.

In step S512, the tab sheets that became no longer necessary are discharged from the sheet tray currently being processed to the unnecessary tab sheet discharge tray, which has been stored in the memory. Then, the tab sheet supply count stored in the memory for the sheet tray being processed is reset to “0” as the tab sheet discharge per set unit is completed. Next, the sheet supply tray after the switch is made is stored in the memory as the sheet supply tray being currently processed in step S513.

Step S512 is executed when, for example, a 3-tab is inserted first, then a 5-tab sheet is inserted, which is followed by an insertion request for a 3-tab request again. It is because, if another 5-tab insertion request is made, a tab sheet with the ⅕ position tab must first be used in this case.

As mentioned above, even if a single copy printing is in process for the printing job, tab sheets that became no longer necessary are discharged. Therefore, even if multiple types of tab sheets are used, it is possible to discharge properly the tab sheets that became no longer necessary. Adopting this process is effective, for example, in the above embodiment, in specifying, for example, the first tab (the 3-tab 500 in the above example) as a chapter tab sheet to be used for “chapters” of a document, and setting up the second tab (the 5-tab 600 in the above example) as a section tab sheet to be used for “sections” of the document. In other words, when it is intended to supply a tab sheet for a chapter after supplying a tab sheet for a section, after which another tab for a section is to be supplied, it is possible to insert the leading tab sheet (e.g., the ⅕-tab 611 of the 5-tab 600 in the above example) since it is the first section of the new chapter.

In general, assuming that the number of sheets being supplied is N and the number of sheets that constitute one set of tab sheets is S, tab sheets are discharged to the unnecessary tab sheet discharge tray in the amount correspondent with the number of discharge cycles expressed by a formula D=S−(remainder of N/S) (except that it is assumed D=0, if D=S). For example, if sheets are supplied 7 times from a 5-tab sheet supply tray, N=7, S=5, and the remainder of 7 divided 5 is 2, so that the calculation becomes D=5−2=3.

As described above, the number of tab sheets supplied is counted per each sheet supply tray, the number of tab sheets that became no longer necessary is calculated based on the count of the number of tab sheets supplied, and the tab sheets that became no longer necessary as calculated are discharged. Therefore, even if multiple types of tab sheets are used, the number of sheets that became no longer necessary per each type of tab sheets can be easily calculated, so that the tab sheets that became no longer necessary can be discharged without fail.

On the other hand, if the job end is detected in step S516 (S516: Yes, T3 of FIG. 14), tab sheets that became no longer necessary are discharged from all the tab sheet supply trays to respective unnecessary tab sheet discharge trays stored in the memory (S517). For example, according to the job header 310 shown in FIG. 14, the 3-tab sheet 500, which is the first tab sheet is discharged to “Output1” (discharge tray 61), and the 5-tab sheet 600, which is the second tab sheet is discharged to “Output2” (discharge tray 62). The discharge count D of the tab sheets that became no longer necessary is as described before. Also, the tab sheet supply counts stored in the memory for all the sheet trays are reset to “0” as the tab sheet discharge per set unit is completed.

While the discharge control for the unnecessary tab sheet is described to be conducted in accordance with the change in the sheet supplying trays in the flowchart of FIGS. 12 and 13, the discharge control for the unnecessary tab sheet can be conducted in accordance with the change of types of supplied tab sheets as well. In this case, the number of supplied tab sheets is counted, for example, per each type of tab sheet.

As can be seen from the above description, it is possible in this embodiment for the user to specify the setting for controlling the discharge a plurality of types of tab sheets that became no longer necessary separating them in accordance with the type of tab sheets.

As a consequence, the separation of the tab sheets per each type can be done very easily for the purpose of reusing the tab sheets that became no longer necessary, even when multiple types of tab sheets are used.

Moreover, since the setting screen 100, which contains the tab sheet insertion setting part 110 and 120 for setting up the insertion of a plurality of types of tab sheets as well as the tab sheet discharge setting part 150 for setting up the discharge process in such a way as to separate tab sheets that became no longer necessary according to their types, is provided for the user in this embodiment, the user can confirm on a single setting screen both the setting concerning the insertion of a plurality of types of tab sheets and the setting for the discharge of unnecessary tab sheets, thus improving the productivity and sureness of operation.

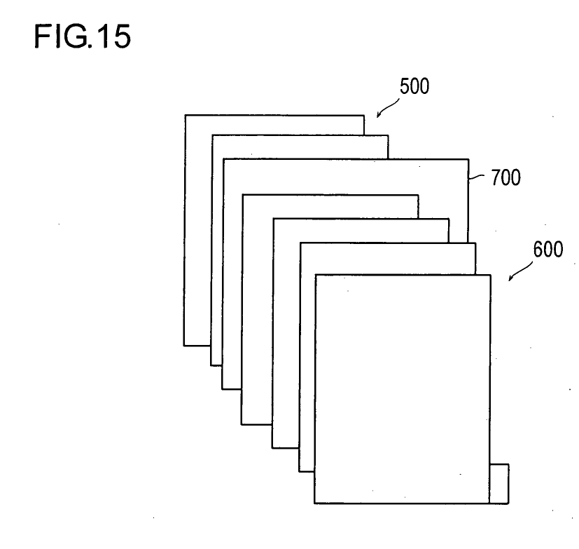

It can also be controlled so as to discharge a plurality of types of tab sheets that became no longer necessary by separating them according to their types by inserting separation sheets at type breaks. In this case, the job header 310 includes descriptions for specifying the separation sheet supply trays instead of descriptions for specifying discharge destinations for tab sheets that became no longer necessary as shown in FIG. 14. For example, the description of “SeparationSheet=Tray3” indicates that the supply tray for the tab sheet separation sheet for tab sheets that became no longer necessary is “Tray 2” (sheet supply tray 53). As the printer 3 identifies a description specifying the separation sheet supply tray in the job header 310, it executes a process similar to the process shown in FIGS. 12 and 13, and discharges the tab sheets 500 and 600 that became no longer necessary by inserting a separation sheet 700 at the tab sheet break position as shown in FIG. 15 when discharging the tab sheets that became no longer necessary (in steps S512 and S517). This also makes it possible to execute the separation of the tab sheets per each type very easily in case of reusing the tab sheets that became no longer necessary.

It can also be controlled so as to discharge a plurality of types of tab sheets that became no longer necessary by offsetting the discharge position by each type of tab sheets. In this case, the job header 310 includes descriptions for offsetting the discharge position by each type of the tab sheets instead of descriptions for specifying discharge destinations for tab sheets that became no longer necessary as shown in FIG. 14. For example, the description of “TabOffset=On” is included in the job header 310. As the printer 3 identifies a description specifying the offsetting of the discharge position by each type of tab sheets in the job header 310, it executes a process similar to the process shown in FIGS. 12 and 13, and discharges the tab sheets 500 and 600 that became no longer necessary by offsetting the discharge positions by each type of tab sheets as shown in FIG. 16 when discharging the tab sheets that became no longer necessary (in steps S512 and S517). This also makes it possible to execute the separation of the tab sheets per each type very easily in case of reusing the tab sheets that became no longer necessary.

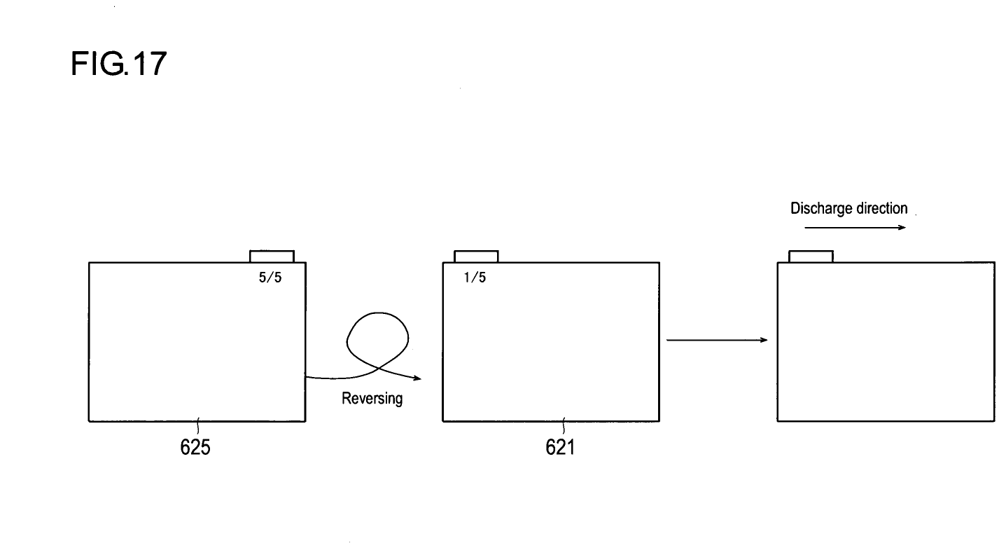

As the printer 3 identifies a description about an instruction specifying the reversing of the unnecessary tab sheets front to back before they are discharged (“TabReverse=On” of FIG. 14) in the job header 310, it reverses and discharges the tab sheets that became no longer necessary by causing them to pass through the reversing mechanism 70 as shown in FIG. 17 when discharging the tab sheets that became no longer necessary (in steps S512 and S517). Further, the tab sheets that became no longer necessary can be reversed front to back by means of the reversing mechanism for double-side printing.

As described in the above, tab sheets that became no longer necessary are reversed by the user's specifying instruction. Thus, the tab sheets that became no longer necessary can be reused as tab sheets with the tab positions different from their original positions. Therefore, tab sheets that became no longer necessary but are otherwise useful as precious constituents of the system can be easily reused without having to reverse manually. More specifically, the tab sheet 625 having the tab position 5/5 can be reused as the tab sheet 621 having the tab position, not 5/5 but ⅕ if its front and back sides are reversed.

Next, the second embodiment will be described below focusing primarily on the points different from the first embodiment.

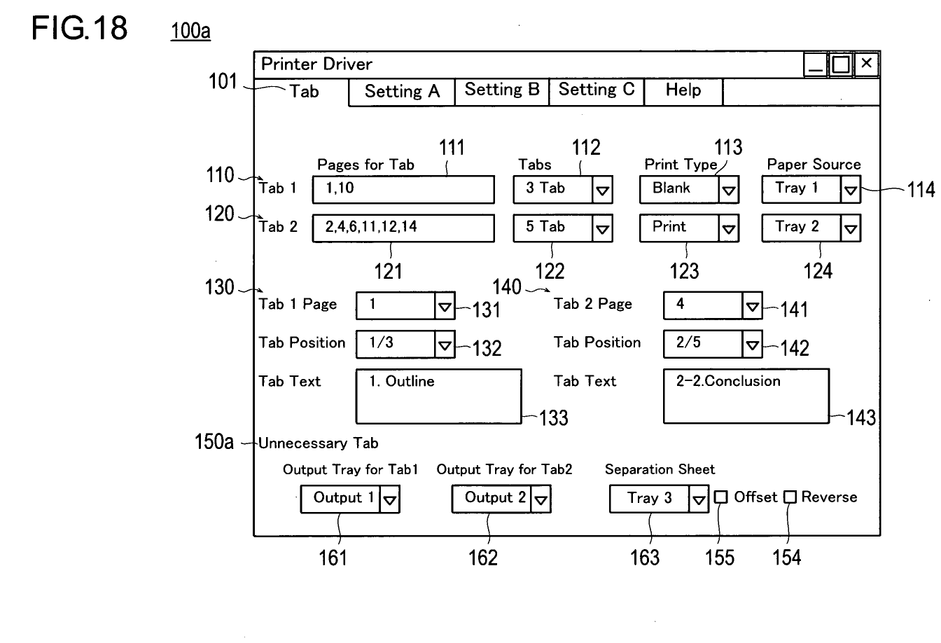

FIG. 18 is an example of tab sheet setting screen 100a in the second embodiment.

The tab sheet discharge setting part 150a on the tab sheet setting screen 100a does not contain the setting parts 151-153, which are the radio buttons of the first embodiment. Moreover, the tab sheet discharge setting part 150a contains the offset setting part 155 by which the user can specify offsetting of the discharge position for tab sheets that became no longer necessary. The offset setting part 155 is a checkbox. When this checkbox is checked, the function for offsetting the discharge position is set up.

In the second embodiment, as shown in FIG. 18, in case when the sheet discharge tray (Output 1 in FIG. 18) specified in the first discharge tray setting part 161 is different from the sheet discharge tray (Output 2 in FIG. 18) specified in the second discharge tray setting part 162, and the sheet supply tray, which is the supply source of the separation sheets (Tray 3 in FIG. 18) is specified in the sheet supply tray setting part 163, it is construed that the user has specified to insert a separation sheet at a break point where the tab positions of the first tab sheets (three-tab sheet in FIG. 18) that are discharged to the sheet discharge tray specified in the first discharge tray setting part 161 change discontinuously, and to insert a separation sheet at a break point where the tab positions of the second tab sheets (five-tab sheet in FIG. 18) that are discharged to the sheet discharge tray specified in the second discharge tray setting part 162 change discontinuously. The break point where the tab position changes discontinuously means a point where the tab position of five-tab sheets changes abruptly departing from the orderly sequence of tab sheets, e.g., to ⅕ after ⅖and ⅗.

Moreover, in the second embodiment, if the sheet discharge tray specified in the first sheet discharge tray setting part 161 is the same as the sheet discharge tray specified in the second sheet discharge tray setting part 162, and the sheet supply tray, which is the source of supply of separation sheets is specified in the sheet supply tray setting part 163, it is construed that the user has specified to discharge a plurality of types of tab sheets that became no longer necessary to the same discharge tray by inserting the separation sheets at the break points where the types of tab sheets change.

Furthermore, in the second embodiment, if the sheet discharge tray specified in the first sheet discharge tray setting part 161 is different from the sheet discharge tray specified in the second sheet discharge tray setting part 162, and the user entered a check mark in the offset setting part 155, it is construed that the user has specified to offset the discharge positions at a breakpoint where the tab positions of the first tab sheets (three-tab sheet in FIG. 18) that are discharged to the sheet discharge tray specified in the first discharge tray setting part 161 change discontinuously, and at a break point where the tab positions of the second tab sheets (five-tab sheet in FIG. 18) that are discharged to the sheet discharge tray specified in the second discharge tray setting part 162 change discontinuously.

Furthermore, in the second embodiment, if the sheet discharge tray specified in the first sheet discharge tray setting part 161 is the same as the sheet discharge tray specified in the second sheet discharge tray setting part 162, and the user has entered a checkmark in the offset setting part 155, it is construed that the user has specified to discharge a multiple types of tab sheets that became no longer necessary to the same sheet discharge tray by offsetting the discharge positions by the types of tab sheets.

According to the second embodiment constituted in such a way, in addition to achieving the same effect as those of the first embodiment, it is possible to form a useful set consisting of a plurality of tab sheets from tab sheets that became no longer necessary as it is easy to identify the breakpoints where the tab positions of the tab sheets discharged to the sheet discharge tray change discontinuously, so that it is more advantageous in reusing the tab sheets that became no longer necessary.

Next, the third embodiment will be described below focusing primarily on the points different from the second embodiment.

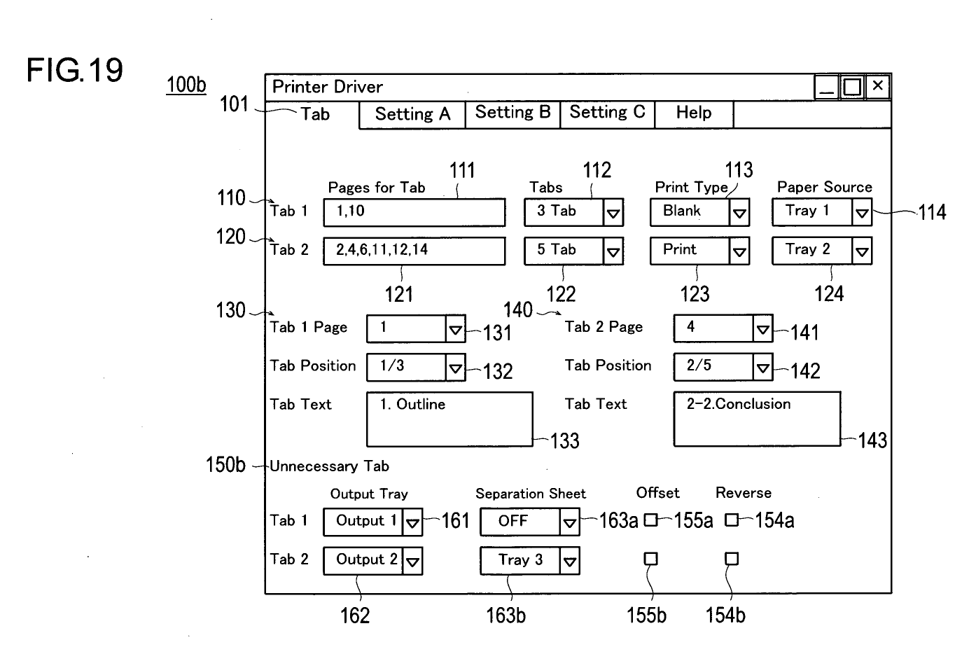

FIG. 19 is an example of tab sheet setting screen 100b in the third embodiment.

The tab sheet discharge setting part 150b in the tab sheet setting screen 100b contains the sheet supply tray setting part 163a that enables the user to specify the sheet supply tray, which is the source of supply for the separation sheets concerning the first tab sheets that became no longer necessary and the sheet supply tray setting part 163b that enables the user to specify the sheet supply tray, which is the source of supply for the separation sheets concerning the second tab sheets that became no longer necessary. Furthermore, the tab sheet discharge setting part 150b contains the offset setting part 155a that enables the user to issue an instruction to offset the discharge position for the first tab sheets that became no longer necessary and the offset setting part 155b that enables the user to issue an instruction to offset the discharge position for the second tab sheets that became no longer necessary. Furthermore, the tab sheet discharge setting part 150b contains the reversing setting part 154a that enables the user to issue an instruction to discharge the first tab sheets that became no longer necessary by reversing them front to back and the reversing setting part 154b that enables the user to issue an instruction to discharge the second tab sheets that became no longer necessary by reversing them front to back.

In the third embodiment, as shown in FIG. 19, in case when the sheet discharge tray (Output 1 in FIG. 18) specified in the first discharge tray setting part 161 is different from the sheet discharge tray (Output 2 in FIG. 18) specified in the second discharge tray setting part 162, and the sheet supply tray, which is the supply source of the separation sheets, is specified in the sheet supply tray setting part 163a, it is construed that the user has specified to insert a separation sheet that is supplied from the sheet supply tray, which is specified in the sheet supply tray setting part 163a, at a breakpoint where the tab positions of the first tab sheets that are discharged to the discharge tray specified in the first discharge tray setting part 161 change discontinuously. Similarly, when the sheet supply tray, which is the source of supply of the separation sheets, is specified in the sheet supply tray setting part 163b, it is construed that the user has specified to insert a separation sheet that is supplied from the sheet supply tray, which is specified in the sheet supply tray setting part 163b, at a breakpoint where the tab positions of the second tab sheets that are discharged to the discharge tray specified in the second discharge tray setting part 162 changed is continuously. Thus, it is possible in the third embodiment to specify the insertion of a separation sheet at the breakpoint, where a discontinuous change of the tab positions of the first tab sheets occurs, independently from the insertion of a separation sheet at the breakpoint, where a discontinuous change of the tab positions of the second tab sheets change occurs, thus it is possible to specify the supply tray for insertion sheets in the two cases independently. Moreover, it is possible to specify “OFF” in the sheet supply tray setting parts 163a and 163b as shown in FIG. 19. In this case, no separation sheet is inserted at the breakpoint where a discontinuous change of the tab positions of the corresponding tab sheets occurs.

Furthermore, in the third embodiment, if the sheet discharge tray specified in the first sheet discharge tray setting part 161 is different from the sheet discharge tray specified in the second sheet discharge tray setting part 162, and the user entered a check mark in the offset setting part 155a, it is construed that the user has specified to offset the discharge positions at a breakpoint where the tab positions of the first tab sheets that are discharged to the sheet discharge tray specified in the first discharge tray setting part 161 change discontinuously. Similarly, if a check mark is entered in the offset setting part 155b, it is construed that the user has specified to offset the discharge positions at a breakpoint where the tab positions of the second tab sheets that are discharged to the sheet discharge tray specified in the second discharge tray setting part 162 change discontinuously. As can be seen from the above, in the third embodiment, it is possible to specify offsets for the discharge positions at the breakpoint where a discontinuous change of the tab positions of the first tab sheets occurs and at the breakpoint where a discontinuous change of the tab positions of the second tab sheets occurs independently.

It is possible in the third embodiment for the user to instruct the insertion of separation sheets only for the second tab sheets (five-tab sheets in FIG. 19) at the breakpoints where discontinuous change of the tab positions occur, since it is not so difficult as shown in FIG. 19 to form a useful set consisting of a plurality of tab sheets that became no longer necessary for the first tab sheets (three-tab sheets), skipping the insertion of separation sheets at the breakpoints where discontinuous change of the tab positions occur for the latter group.

Moreover, in the third embodiment, it is possible to specify the reverse discharge for discharging the first tab sheets that became no longer necessary reversing them front to back independently from specifying the reverse discharge for discharging the second tab sheets that became no longer necessary reversing them front to back.

As can be seen from the above, in addition to achieving the same effect as the second embodiment, the ease of use is further enhanced for the user in the third embodiment.

The invention is not limited to the embodiment described above, but also can be changed in various ways within the scope of the claims.

For example, in the aforementioned embodiments, although it is constituted in such a way that the settings for the first tab sheets and the second tab sheets are conducted on the tab sheet setting screen, it can also be constituted in such a way that the setting is conducted more specifically for the chapter tab sheets used for “chapters” of a document and the section tab sheets used for “sections” of a document respectively. Also, although a case of two types of tab sheets are inserted is described in the above embodiments, the present invention is applicable to a case inserting more three or more types of tab sheets.

Moreover, although it is described in the above embodiment a case of the process of setting up tab sheets being executed by the printer driver, it can be executed by an application instead of the printer driver.

Further, although it is described in the above embodiment a case of the setting concerning tab sheets is conducted using the tab sheet setting screen, which is displayed on the display 15 of the PC 1, it can be executed using the tab sheet setting screen, which is displayed on the operating panel unit 34 of the printer 3.

Furthermore, although it is describe in the above embodiment a constitution wherein the printing system 4 is divided into the printer controller 2 and the printer 3, both of which are locally connected, the printer controller 2 can be built into the printer 3.

Also, although the embodiments described above uses a printer as the image forming apparatus, the invention is not limited to it. The present invention is applicable to an image forming apparatus such as MFP (Multi-Function Peripheral) and a copying machine as well. Furthermore, although it is assumed that the tab sheet insertion apparatus constitutes a portion of the image forming apparatus, the image forming apparatus and the tab sheet insertion apparatus can be constituted separately if there is no need to print on the tab sheets to be inserted. In this case, printing on the sheets is done on the image forming apparatus and the bundle of the printed sheets is loaded onto the collator apparatus, which functions as either an online or offline tab sheet insertion apparatus. The collator apparatus is equipped with multiple stage feeding trays for insertion paper and those trays store tab sheets with various tab types. The collator apparatus transports a tab sheet of a specific tab type to be inserted in the specified page position, while it also transports sheets from the loaded bundle of sheets one sheet at a time. Under such a constitution, among various settings set up by the printer driver of the printing instruction apparatus, the setting concerning printing is received by the image forming apparatus while the setting concerning the tab sheet insertion is received by the collator apparatus.

The means and method of conducting various processes in the network system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a memory unit such as a hard disk. Said program can also be provided as independent application software or can be built into the software of the image processing device as a part of its function.

1. A computer readable recording medium stored with a control program for controlling a tab sheet insertion apparatus, said control program causing a computer to execute a process comprising:
providing a user with a setting screen having a tab sheet insertion setting part and a tab sheet discharge setting part, the tab sheet insertion setting Dart being for the user's conducting insertion setting concerning insertion of tab sheets of a plurality of types, a while the tab sheet discharge setting part being for the user's conducting discharge setting for, depending on the types, discharging and classifying tab sheets that became no longer necessary; and
receiving said insertion setting and said discharge setting specified by the user via said setting screen.

2. The computer readable recording medium as claimed in claim 1, wherein
said tab sheet discharge setting part comprises a first tab sheet discharge destination setting part which enables the user to specify a first discharge destination for a first tab sheet that became no longer necessary, and a second tab sheet discharge destination setting part which enables the user to specify a second discharge destination for a second tab sheet that became no longer necessary.

3. The computer readable recording medium as claimed in claim 2, wherein
said tab sheet discharge setting part further comprises a tab position separation setting part which enables the user to specify insertion of a separation sheet at a breakpoint where the tab position of the first tab sheets that are discharged to said first discharge destination changes discontinuously, and at a breakpoint where the tab position of the second tab sheets that are discharged to said second discharge destination changes discontinuously.

4. The computer readable recording medium as claimed in claim 2, wherein
said tab sheet discharge setting part further comprises a first tab position separation setting part that enables the user to specify insertion of a separation sheet at the breakpoint where the tab position of the first tab sheets that are discharged to the first discharge destination changes discontinuously and a second tab position separation setting part that enables the user to specify insertion of a separation sheet at the breakpoint where the tab position of the second tab sheets that are discharged to the second discharge destination changes discontinuously.

5. The computer readable recording medium as claimed in claim 2, wherein
said tab sheet discharge setting part further comprises a tab position offset setting part which enables the user to specify offsetting of the discharge position of the tab sheet at the breakpoint where the tab position of the first tab sheets that are discharged to said first discharge destination changes discontinuously, and at the breakpoint where the tab position of the second tab sheets that are discharged to said second discharge destination changes discontinuously.

6. The computer readable recording medium as claimed in claim 2, wherein
said tab sheet discharge setting part further comprises a first tab position offset setting part that enables the user to specify offsetting of the discharge position of the tab sheet at the breakpoint where the tab position of the first tab sheets that are discharged to said first discharge destination changes discontinuously, and a second tab position offset setting part that enables the user to specify offsetting of the discharge position of the tab sheet at the breakpoint where the tab position of the second tab sheets that are discharged to said second discharge destination changes discontinuously.

7. The computer readable recording medium as claimed in claim 2, wherein
said tab sheet discharge setting part further comprises a first reversing setting part that enables the user to specify discharge of the first tab sheet that became no longer necessary by reversing them front to back and a second reversing setting part that enables the user to specify discharge of the second tab sheet that became no longer necessary by reversing them front to back.

8. The computer readable recording medium as claimed in claim 1, wherein
said tab sheet discharge setting part comprises a tab sheet type separation setting part that enables the user to specify discharge of the tab sheets with a separation sheet inserted at a breakpoint where the type of the tab sheets that became no longer necessary changes.

9. The computer readable recording medium as claimed in claim 1, wherein
said tab sheet discharge setting part comprises a tab sheet type offset setting part that enables the user to specify offsetting the discharge position of the tab sheet that became no longer necessary depending on the tab sheet type.

10. A controlling method for controlling an tab sheet insertion apparatus comprising:
providing a user a setting screen having a tab sheet insertion setting part for conducting insertion setting concerning insertion of tab sheets of a plurality of types, and a tab sheet discharge setting part for conducting discharge setting for discharging tab sheets that became no longer necessary classifying the tab sheets depending on the types; and
receiving said insertion setting and said discharge setting specified by the user via said setting screen.
